(19) United States
(12) Patent Application Publication
(10) Pub. No.: US 2009/0153805 A1
(43) Pub. Date: Jun. 18, 2009

(54) PORTABLE PROJECTOR WITH A HEAT DISSIPATION SYSTEM

(75) Inventors: XU LI, Shenzhen (CN); GEN-PING DENG, Shenzhen (CN); CHUN-CHI CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 11/957,351

(22) Filed: Dec. 14, 2007

(51) Int. Cl. G03B 21/16

(52) U.S. Cl. 353/57

(57) ABSTRACT

A portable projector includes a housing, a first light source and a second light source located in the housing. A board thermally contacts the first light source for absorbing heat from the first light source. A heat pipe connects the board and a first heat sink for transferring the heat generated by the first light source from the board to the first heat sink. A second heat sink thermally contacts the second light source for dissipating heat from the second light source.

### BACKGROUND OF THE INVENTION

1. Field of the Invention

The present invention relates to a portable projector, and more particularly to a portable projector with a heat dissipation system.

2. Description of Related Art

Since projectors have become increasingly popular, the requirements of potable projectors have grown too. Projectors are high precision opto-mechatronics products; their components are highly temperature sensitive, and have a very complicated layout. Consequently, the cooling capabilities of the projector are very important. In particular, improving cooling capabilities without increasing the size of the projector is of interest.

Generally, the related art projector requires a very high brightness to obtain good quality images, and so needs a high power light source. Therefore, after a long period of operation, the light source generates large amounts of heat within the projector. In addition to the heat generated by the light source, the power supply and imaging system of the projector also generate heat during the operation. Furthermore, the heat generated by the light source, the imaging system, and the power supply are all collected in the projector, which leads to high temperatures that affect the operations of the projector and reduces the life times of the other elements.

What is needed therefore is to proved a portable projector with a heat dissipation system to ensure perfectly operation of the projector.

### SUMMARY OF THE INVENTION

A portable projector with a heat dissipation system in accordance with a preferred embodiment of the present invention comprises a housing, a first light source and a second light source located in the housing. A board thermally contacts the first light source for absorbing heat from the first light source. A heat pipe connects the board and a first heat sink for transferring the heat generated by the first light source from the board to the first heat sink. A second heat sink thermally contacts the second light source for dissipating heat from the second light source.

### BRIEF DESCRIPTION OF THE DRAWINGS

Many aspects of the present portable projector with a heat dissipation system can be better understood with reference to the following drawings. The components in the drawings are not necessarily drawn to scale, the emphasis instead being placed upon clearly illustrating the principles of the present portable projector using a heat dissipation system. Moreover, in the drawings, like reference numerals designate corresponding parts throughout the several views.

FIG. 1 is an isometric, assembled view of a portable projector with a heat dissipation system in accordance with a preferred embodiment of the present invention;

FIG. 2 is a top plan view of FIG. 1;

FIG. 3 is an exploded view of the heat dissipation system with two light sources of FIG. 1; and

FIG. 4 is an assembled view of the heat dissipation system of FIG. 3.

### DETAILED DESCRIPTION OF THE INVENTION

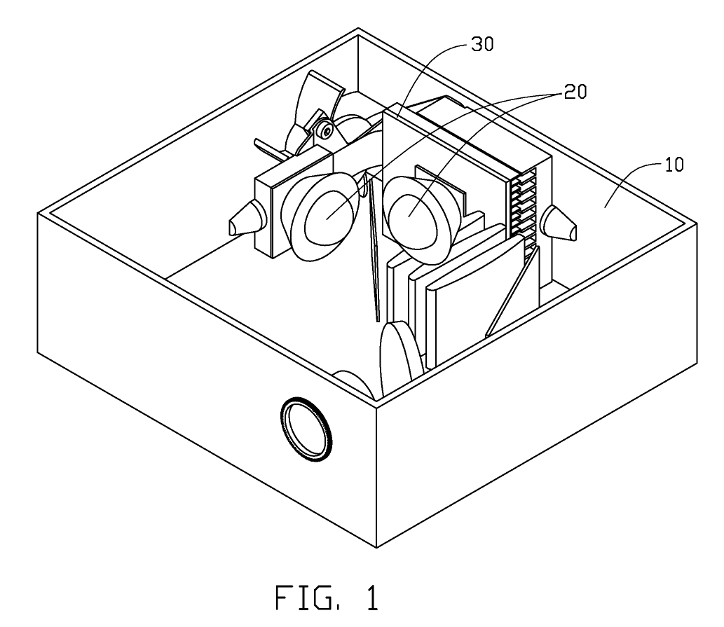

Referring to FIGS. 1-4, a portable projector with a heat dissipation system is shown. The projector comprises a housing 10, two light sources 20 positioned in the housing 10, and a heat dissipation system 30 thermally connecting with the light sources 20 in the housing 10.

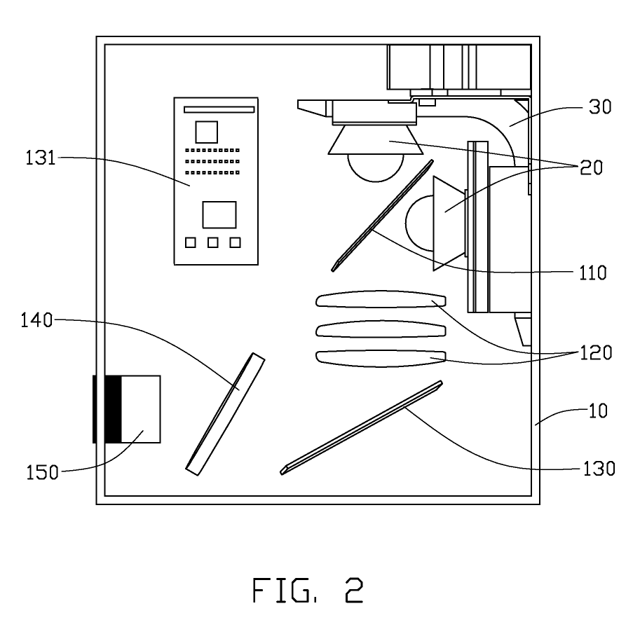

As shown in FIGS. 1 and 2, the light sources 20 placed in the housing 10 are used for providing light when the projector is operating. The light sources 20 are preferably LED devices, which can reduce the power consumption of the projector and reduce operating heat load. Although there are a first and a second light sources 20 shown in this embodiment, no limiting amount of the first and second light sources 20 can be shown in other alternative embodiments. In this embodiment, the first and second light sources 20 have light directions thereof perpendicular to each other. A first light condenser 110 is diagonally positioned between the two light sources 20. Light from the first and second light sources 20 is collected by the first light condenser 110 and then perpendicularly passes through spectroscopes 120 which are angled to the first light condenser 110. The light from the spectroscopes 120 is angularly reached a liquid crystal panel 130 which is a little distance to the spectroscope 120 and is controlled by a control circuit 131. A second light condenser 140 is confronted to the liquid crystal panel 130 and collects the light from the liquid crystal panel 130 to reach a lens module 150 which passes through the housing 10. Therefore, images than can be obtained at a screen (not shown).

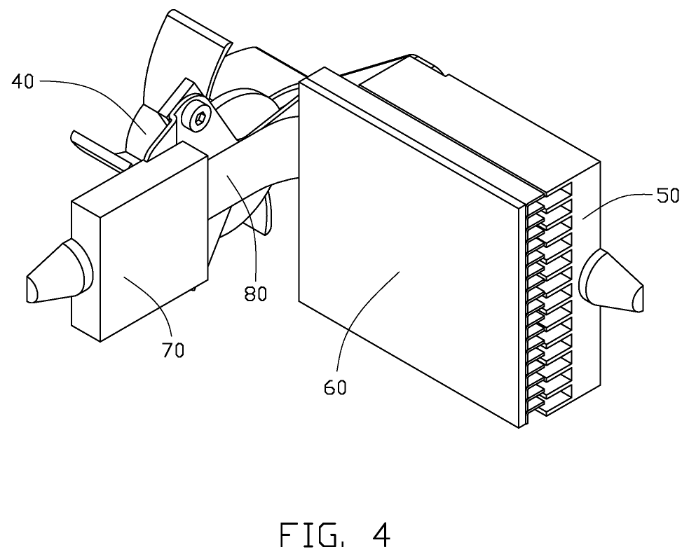

The heat dissipation system 30 comprises a fan 40 (shown in FIG. 4), a first heat sink 50 and a second heat sink 60 located at a side of the fan 40, a board 70, a heat pipe 80 connecting with the board 70 and the first heat sink 50.

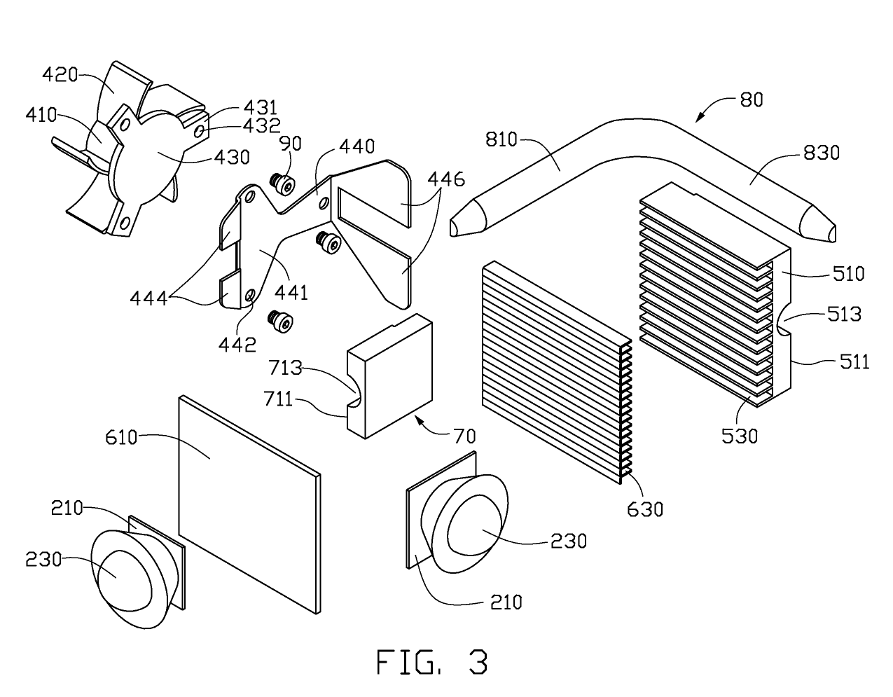

Referring also to FIGS. 3 and 4, the fan 40 comprises a hub 410, a plurality of blades 420 circumferentially extending from the hub 410, and a plate 430 extending from an end from the hub 410. The plate 430 is integrally formed with the hub 410 from one-piece member, and has a diameter larger than that of the hub 410. The plate 430 evenly extends three fixing arms 431 from a circumference thereof for fixing the fan 40 to a fixing member 440. Each fixing arm 431 defines a fixing hole 432 adjacent to a distal end thereof. The fixing member 440 has a sheet configuration, and comprises a fixing portion 441, two first fixing legs 444 extending from a side of the fixing portion 441, and two second fixing legs 446 extending from an opposite side of the fixing portion 441. The fixing portion 441 is substantially T-shaped, and defines three fixing holes 442 according to the fixing holes 432 of the fan 40, in three corners thereof, respectively. The two first fixing legs 444 define a space therebeween for accommodating the heat pipe 80. The two second fixing legs 446 define a space therebetween for accommodating the heat pipe 80. The second fixing leg 446 has a length larger than that of the first fixing leg 444.

The first heat sink 50 is made from one-piece metal member, and comprises a first base 510 and a plurality of spaced first fins 530 integrally extending from the first base 510. The first base 510 defines a groove 513 in a face 511 thereof, the grooves 513 goes along a length direction of the first fins 530. The face 511 of the first base 510 has an end thereof defining a recess (not labeled) for accommodating the second fixing legs 446 of the fixing member 440.

The second heat sink 60 comprises a second base 610 and a plurality second fins 630 arranged on the base 610. Each second fin 630 is made from one-piece metal sheet, and comprises a contacting portion (not labeled) thermally contacting the second base 610 and a dissipating portion (not labeled) perpendicular to the second base 610.

The heat pipe 80 has a phase-changeable working fluid sealed therein. The heat pipe 80 is substantially L-shaped, and comprises a first transfer section 810 and a second transfer section 830 substantially perpendicular to the first transfer section 810. The heat pipe 80 has a flat face (not labeled) extending from the first transfer section 810 to the second transfer section 830. The first transfer section 810 and the second transfer section 830 each have a semi-circular cross section. The heat pipe 80 is positioned at a corner of the housing 10.

The board 70 is a substantially rectangular plate and defines a groove 713 in a face 711 thereof. The face 711 defines a recess (not labeled) at an end portion thereof for accommodating the first fixing legs 444 of the fixing member 440.

Particularly referring to FIG. 4, in an assemble of the heat dissipation system, the second heat sink 60 is attached to the first heat sink 50. The first fins 530 and the second fins 630 are located between the first base 510 and the second base 610. The second fins 630 face to the first fins 530 of the first heat sink 50. The heat pipe 80 has the second transfer section 830 thermally received in the groove 513 of the first base 510. The first transfer section 810 of the heat pipe 80 is received the groove 713 of the board 70. The first fixing legs 444 of the fixing member 440 is accommodated in the recess of the board 70, the second fixing legs 446 is accommodated in the recess of the first base 510 of the first heat sink 50. The fan 40 is fixed to the fixing member 440 via fasteners 90 engaged in corresponding fixing holes 432, 442 of the fan 40 and the fixing member 440.

Referring back to FIGS. 1 and 3, the first and second light sources 20 each comprise a circuit board 210 and an LED device 230 mounted on the circuit board 210. The circuit boards 210 of the first and second light sources 20 thermally contact the board 70 and the second base 610 of the second heat sink 60, respectively.

In use, the first and second light sources 20 emit light and generate heat. The heat generated by the first light source 20 reaches the board 70 and is absorbed by the first transfer section 810 of the heat pipe 80. The heat in the heat pipe 80 is transferred to the first heat sink 50 via the second transfer section 830, then is dissipated to ambient by the first heat sink 50 by virtue of airflow from the fan 40. The heat generated by the second light source 20 is absorbed by the second heat sink 60 and is dissipated to ambient air by virtue of airflow from the fan 40.

In the embodiment, the heat generated by the light sources 20 is directly removed via the heat pipe 80 and the second heat sink 60, heat dissipation efficiency is improved. Additionally, the fan 40 provides airflow not only to the first and second heat sinks 50, 60 and the light sources 20, but also to other members in the housing 10 of the projector. Therefore, heat generated by multi-members in the housing 10 can be removed duly. Furthermore, the heat dissipation assembly 30 is positioned at the side of the housing 10, the heat pipe 80 is L-shaped according to the corner of the housing 10, therefore, the heat dissipation system 30 occupies a small space in the housing, layout of the members in the housing 10 is optimized, and space of housing 10 is saved.

It is believed that the present invention and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A projector comprising:
a housing;
a first light source and a second light source located in the housing;
a board thermally contacting the first light source for absorbing heat from the first light source;
a first heat sink;
a heat pipe connecting the board and the first heat sink for transferring heat from the board to the first heat sink; and
a second heat sink thermally contacting the second light source for dissipating heat from the second light source.

2. The projector of claim 1 further comprising a fan located at a side of the first heat sink and the second heat sink for providing airflow to the first heat sink and the second heat sink.

3. The projector of claim 2, wherein the fan comprises a hub, a plurality of blades extending from the hub, and a fixing plate extending from an end of the hub.

4. The projector of claim 3, wherein the fixing plate is integrally formed with the hub from one-piece member, the fixing plate has a diameter larger than that of the hub.

5. The projector of claim 4, wherein the fixing plate outwardly extends a plurality of arms.

6. The projector of claim 5 further comprising a fixing member engaging with the first heat sink and the board, wherein the fan is fixed to the fixing member via the arms thereof.

7. The projector of claim 6, wherein the fixing member comprises a fixing portion defines a plurality of fixing holes therein, the arms of the fan defining a plurality of fixing holes corresponding to the fixing holes of the fixing member.

8. The projector of claim 7, wherein the fixing member comprises a first leg and a second leg respectively extending from two opposite sides of the fixing portion, the first leg and the second leg engaging with the board and the first heat sink, respectively.

9. The projector of claim 8, wherein the board defines a recess in an end thereof, the first leg of the fixing member is accommodated in the recess.

10. The projector of claim 8, wherein the first heat sink defines a recess in an end portion thereof, the second leg of the fixing member is accommodated in the recess.

11. The projector of claim 1, wherein the first light source and the second light source each comprises a circuit board and an LED device mounted on the circuit board, the circuit boards thermally contacting the board and the second heat sink, respectively.

12. The project of claim 1, wherein the first heat sink comprises a first base and a plurality of first fins extending from the first base.

13. The projector of claim 12, wherein the second heat sink comprises a second base and a plurality of second fins arranged on the second base.

14. The projector of claim 13, wherein the second fins face to the first fins, the first fins and the second fins are located between the first base and the second base.

15. The projector of claim 1, wherein the heat pipe is L-shaped, and comprises a first section contacting the board and a second section contacting the first heat sink.
